(19) United States
(12) Patent Application Publication
(10) Pub. No.: US 2008/0057382 A1
(43) Pub. Date: Mar. 6, 2008

(54) Battery Pack

(76) Inventor: Tadao Kimura, Hyogo (JP)

Correspondence Address: MCDERMOTT WILL & EMERY LLP, 600 13TH STREET, NW, WASHINGTON, DC, 20005-3096, US

(21) Appl. No.: 11/793,191

(22) PCT Filed: Dec. 7, 2005
(86) PCT No.: PCT/JP05/22427

§ 371 Date: Jun. 14, 2007

(30) Foreign Application Priority Data
Dec. 14, 2004 (JP) 2004-361169

(51) Int. Cl. H01M 10/50

(52) U.S. Cl. 429/120

(57) ABSTRACT

A battery pack (2) has a cooling medium passage through which a cooling medium for cooling a rechargeable battery (1) contained in the battery pack flow inside the pack. Oscillating energy generated by a device to which the battery pack is installed is used as a force for making the cooling medium flow. As a result, electric power is not consumed for cooling and accordingly all the electric power can be used for driving the device. Thus, it is possible to drive the device for a longer period of time.

### TECHNICAL FIELD

The present invention relates to a battery pack having the structure which cools its inside, and in particular, relates to a battery pack which achieves cooling without using electric power of a battery.

### BACKGROUND ART

Demand for a battery is growing in accordance with a growing trend to make electric equipment mobile and wireless. In particular, recently the demand for a battery is growing for use as a mechanical power installed in, for example, a hybrid electric vehicle and a power tool. In the case of the use as the mechanical power like this, a battery generates a large amount of heat because of large passing current. However, using the battery at high temperature accelerates the degradation of the battery performance, so that there are many cases in which a mechanism to cool the battery is necessary. Also, since battery characteristics depend on temperature, in the case of a battery pack comprising a plurality of cells, it is important to uniform battery temperatures within the pack.

In order to cool a battery and uniform temperatures as described above, a method is generally used in which a passage for a cooling medium is provided in a battery pack and a motor pump or a motor fan is driven so that the cooling medium flows therethrough. For example, a method is proposed in which a fan or the like makes air flow from a device or a battery charger into a battery pack to cool a battery (see Patent Document 1). [Patent document 1] Japanese Patent Laid-Open Publication No. Hei 11-288744.

### DISCLOSURE OF THE INVENTION

### Problems to be Solved by the Invention

However, in the case where a device does not have any energy source except for a battery such as an electric vehicle and a power tool, the battery should supply energy for making a cooling medium flow. Thus, there is a problem of shortening the driving time of the device.

### Means for Solving the Problems

In light of the foregoing, the present invention has been devised to solve the problem mentioned above, and an object of the present invention is to provide a battery pack which has the structure of effectively cooling the inside of the battery pack without using the electric power of a battery.

In order to achieve the above object, a battery pack according to the present invention includes a rechargeable battery, and a cooling medium passage, through which a cooling medium for cooling the rechargeable battery flows. The battery pack uses oscillating energy as a force for making the cooling medium flow. According to this battery pack, the electric power of the battery is not used for cooling, since the oscillating energy being surplus energy generated in driving a device to which the battery pack is installed is used as the force for making the cooling medium flow. Accordingly, all the electric power of the battery is used for driving the device, so that the device can be driven for a longer period of time.

Using a valve or a rotor which is directly driven by oscillation as means for converting the oscillating energy into the force for making a cooling medium flow improves the efficiency of the cooling medium flow.

Otherwise, a generator, which generates electric power by oscillation, and a device for making the cooling medium flow, which is driven by electric power generated by the generator, can be used as means for converting the oscillating energy into the force for making the cooling medium flow. In this case, the efficiency of the cooling medium flow is further improved.

### BRIEF DESCRIPTION OF THE DRAWINGS

FIG. 1 is a schematic view showing the internal structure of a battery pack according to an embodiment of the present invention; and

FIG. 2 is a schematic view showing the internal structure of a battery pack according to another embodiment of the present invention.

### BEST MODE FOR CARRYING OUT THE INVENTION

Embodiments of the present invention will be hereinafter described with reference to the drawings in order to provide better understanding of the invention. The following embodiments are examples embodying the present invention and do not limit the technical scope of the present invention.

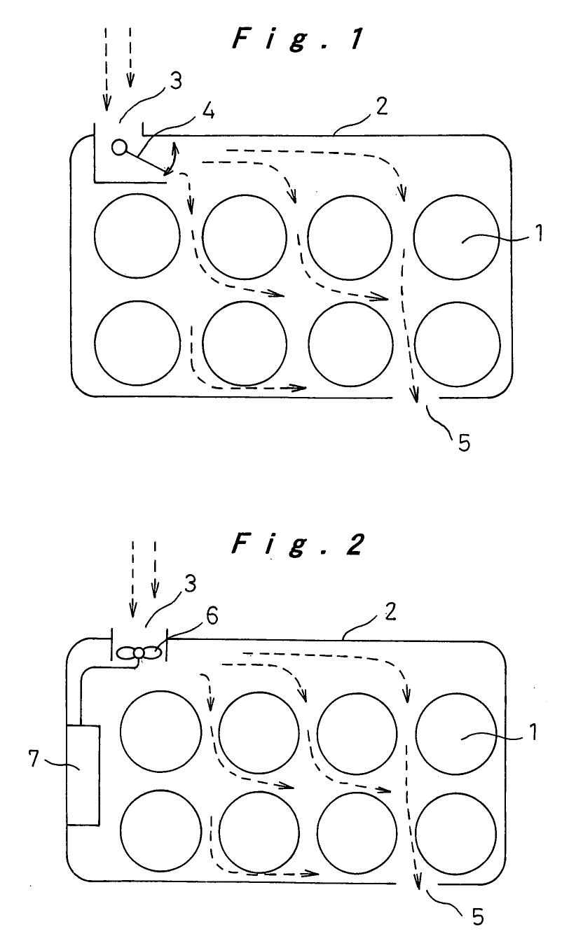

FIG. 1 shows an example of a battery pack 2 which uses a valve that is driven by oscillation to make a cooling medium flow. The battery pack 2 contains rechargeable batteries 1. Cooling air (outside air of the battery pack 2) is used as the cooling medium for cooling the rechargeable batteries 1. An oscillating valve 4 which is movable with respect to a supporting point by the oscillation is provided inside of an inlet 3 for taking the cooling air in.

In operating a device in which the battery pack 2 is installed, a motor or the like is driven to generate oscillation and the battery pack 2 installed in the device oscillates together. The oscillating valve 4 swings with respect to the supporting point like a paper fan in synchronization with the oscillation, so that the cooling air is taken from the inlet 3 into the battery pack 2. The cooling air cools the rechargeable batteries 1 while passing through cooling medium passages including the clearance between the rechargeable battery 1 and an inner wall of the battery pack and the clearance between the adjacent rechargeable batteries 1. Then the cooling air is discharged from an outlet 5 to the outside of the battery pack 2. During this operation, energy used for cooling the rechargeable batteries 1 is only oscillating energy supplied to the battery pack 2 and the rechargeable battery 1 never supplies any energy for cooling. As a result, it is possible to use the device for a longer period of time because of reducing waste electric power consumption.

In the present embodiment, an example has been described in which the oscillating valve 4 which is movable with respect to the supporting point like the paper fan by the oscillation is used. However, using a mechanism which mechanically operates a fan (rotor) by means of a structure like a crank which directly converts reciprocating oscillation into rotational motion also provides a similar effect.

FIG. 2 shows an example of a battery pack 2 which uses an oscillating generator 7 generating electric power by oscillation and an electric fan 6 driven by the generated electric power to make a cooling medium flow.

The battery pack 2 contains rechargeable batteries 1, and cooling air (outside air of the battery pack 2) is used as a cooling medium for cooling the rechargeable batteries 1. The electric fan 6 serving as a device for making the cooling medium flow is provided inside of an inlet 3 for taking the cooling air in. The oscillating generator 7 disposed in the battery pack 2 supplies electric power to the electric fan 6.

In operating a device in which the battery pack 2 is installed, a motor or the like is driven to generate oscillation, and the battery pack 2 installed in the device oscillates together. The oscillating generator 7 generates the electric power by the oscillation. The electric power is supplied to the electric fan 6, and the cooling air is taken from the inlet 3 into the battery pack 2 by the operation of the electric fan 6. The cooling air taken in the battery pack 2 cools the rechargeable batteries 1 while passing through cooling medium passages including the clearance between the rechargeable battery 1 and an inner wall of the battery pack and the clearance between the adjacent rechargeable batteries 1. Then the cooling air is discharged from an outlet 5 to the outside of the battery pack 2. During this operation, energy used for cooling the rechargeable batteries 1 is only oscillating energy supplied to the battery pack 2 and the rechargeable battery 1 never supplies any energy for cooling. As a result, it is possible to use the device for a longer period of time because of reducing waste electric power consumption.

The cooling air is used as the cooling medium in these embodiments, but liquid such as water is also available as a cooling medium. In such a case, a motor pump which is driven by electric power generated by an oscillating generator 7 may be used as a device for making the cooling medium flow and a water jacket may be provided around a rechargeable battery 1.

FIGS. 1 and 2 show an example in which the battery pack 2 contains a plurality of rechargeable batteries 1. The number of rechargeable batteries 1 contained in the battery pack 2 is not limited to the example and may be one.

### INDUSTRIAL APPLICABILITY

As described above, according to a battery pack of the present invention, a cooling medium for cooling the inside of the battery pack is made to flow through the use of oscillating energy generated by a device to which the battery pack is installed. Thus, it is not necessary to use the electric power of a battery for cooling, and all the electric power of the battery can be used for driving the device without using it for cooling. Consequently, the battery pack is suitable for being used as the mechanical power of a hybrid electric vehicle, a power tool, and the like.

1. A battery pack comprising:
a rechargeable battery (1); and
a cooling medium passage through which a cooling medium for cooling the rechargeable battery flows, wherein
the battery pack uses oscillating energy as a force for making the cooling medium flow.

2. The battery pack according to claim 1, wherein a valve (4) or a rotor (6) which is directly driven by oscillation is used in order to make the cooling medium flow.

3. The battery pack according to claim 1, further comprising an oscillating generator (7) generating electric power by oscillation, and a device (6) which is driven by electric power generated by the oscillating generator and makes the cooling medium flow.

4. The battery pack according to claim 1, wherein an outside air of the battery pack (2) is used as the cooling medium.

5. The battery pack according to claim 1, further comprising a water jacket provided around the rechargeable battery (1), an oscillating generator (7) generating electric power by oscillation, and a pump which is driven by electric power generated by the oscillating generator, and wherein a liquid cooling medium is used.
